(19) United States
(12) Patent Application Publication
(10) Pub. No.: US 2012/0187850 A1
(43) Pub. Date: Jul. 26, 2012

(54) Nightlight Driving Device

(76) Inventor: Li-Chun LAI, New Taipei City (TW)

(21) Appl. No.: 13/012,071

(22) Filed: Jan. 24, 2011

(51) Int. Cl. H05B 37/02

(52) U.S. Cl. 315/158

(57) ABSTRACT

A nightlight driving device is disclosed, comprising a power input module, a current limiting module, a triac, a photo-sensing module, a filter module and a light emitting diode (LED), wherein the filter module inputs a stable current into the LED and the power input module provides the power required for entire operations; therefore, when the photo-sensing module is located in a daytime environment, the photo-sensing module causes the triac not to be driven to conduct and the LED can not illuminate; on the other hand, in case the photo-sensing module is in a nighttime environment, the triac can be driven to conduct thereby enabling illumination of the LED so as to effectively save the power consumed by the nightlight.

### BACKGROUND OF THE INVENTION

1. Field of the Invention

The present invention relates to a nightlight driving device; in particular, it relates to a driving device which effectively simplifies the circuitry construction and saves the power consumed by the nightlight.

2. Description of Related Art

A driving device 1 for the commercially available nightlight at present days is shown in FIGS. 1 and 2, comprising a power input module 11, a resistance-capacitance buck module 12, a current limiting module 13, a current rectifying module 14, a voltage stabilizing module 15, a filter module 16, a photo-sensing module 17 having a photosensitive resistor, a triode 18 and a light emitting diode (LED) 19, wherein the triode 18 is respectively connected to the photo-sensing module 17 and the LED 19, and the power input module 11 provides the electric power required for entire operations. Hence, in case that the photosensitive resistor in the photo-sensing module 17 detects the nighttime, the current will flow through the power input module 11, resistance-capacitance buck module 12, current limiting module 13, current rectifying module 14, voltage stabilizing module 15, filter module 16, photo-sensing module 17 and triode 18, and then finally into the LED 19 to enable illumination thereof. Therefore, it can be understood that the high intensity of light during daytime can cause the resistance of the photosensitive resistor in the photo-sensing module 17 to reduce thereby creating a short-circuit state in the triode 18 such that the LED 19 does not illuminate. On the other hand, the weak intensity of light during nighttime can cause the resistance of the photosensitive resistor in the photo-sensing module 17 to rise up thus generating an open-circuit state in the triode 18 which drives the LED 19 to illuminate.

However, for the aforementioned driving circuit, the voltage stabilizing module 15 and triode 18 still consume electrical energy in a consistent fashion even located in an environment of strong intensity of light during daytime, which, in the new generation emphasizing the aspects of low carbon trace, green energy and environmental protection, may be considered as undesirably leading to serious wastage of resources by cumulatively using such a type of nightlight. Consequently, it would be an optimal solution to provide a nightlight driving device which can effectively save unnecessary power consumptions by driving the LED to illuminate only during nighttime and also minimizing the power consumed by the nightlight driving device during daytime.

Also, the conventional nightlight circuit is relatively complicated which adversely leads to increased manufacture costs and work times with regards to economic effectiveness.

### SUMMARY OF THE INVENTION

An objective of the present invention is to provide a nightlight driving device which can effectively simplify the circuitry construction thereby achieving the purposes of cost saving and work time reduction.

Another objective of the present invention is to provide a nightlight driving device using a triac as the switch to turn on/off the LED, in which the triac consumes no electric power when the LED does not emit light during daytime thereby achieving the purpose of energy saving.

A nightlight driving device enabling achievements of aforementioned objectives comprises: a power input module, used to provide the electric power required for entire operations and able to input a current; a light emitting diode (LED), connected to the power input module in order to illuminate; a filter module, respectively connected to the power input module and the LED and capable of inputting a stable current into the LED; a triac, respectively connected to the power input module and the filter module which, in case of conductivity in the triac, allows a current to enter into the LED through the filter module; a current limiting module, respectively connected to the power input module and the filter module, which, in case of conductivity in the triac, limits the current flowing into the LED; a photo-sensing module, respectively connected to the power input module and the triac, which determines the conductivity in the triac based on the intensity of light.

In one embodiment of the present invention, the photo-sensing module includes a photosensitive resistor CDS and a resistor R, wherein the resistance of the photosensitive resistor CDS can vary based on the intensity of light.

In one embodiment of the present invention, the current limiting module is a current limiting resistor R.

In one embodiment of the present invention, the filter module includes a capacitor and a resistor thereby forming an RC filter circuit.

### BRIEF DESCRIPTION OF THE DRAWINGS

FIG. 1 shows a diagram for the integral architecture of a conventional driving device;

FIG. 2 shows a diagram for the circuit implementation of a conventional driving device;

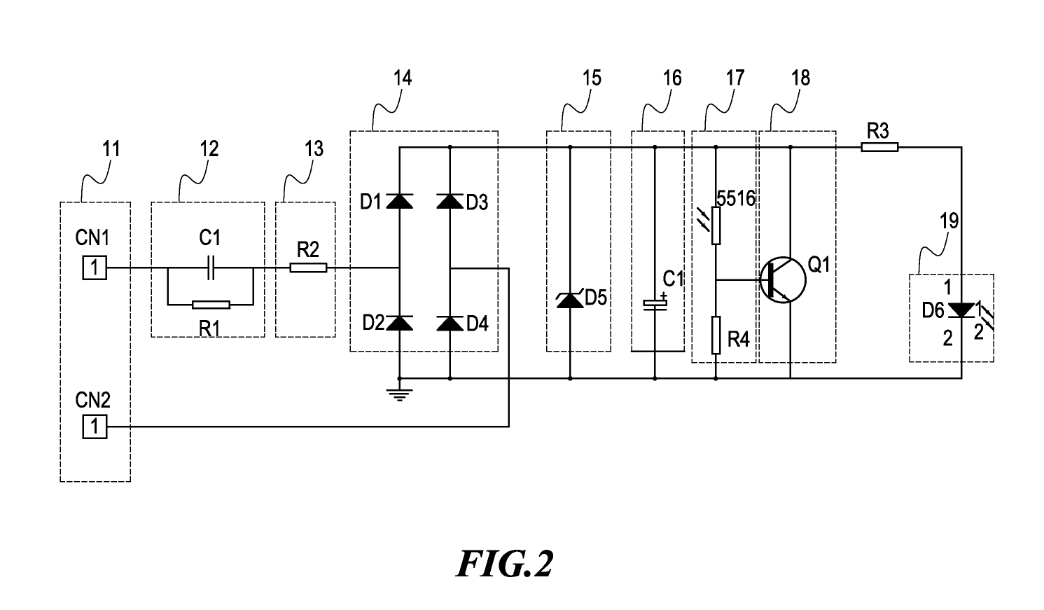

FIG. 3 shows a diagram for the integral architecture of the nightlight driving device according to the present invention;

FIG. 4 shows a diagram for the circuit implementation of the nightlight driving device according to the present invention; and

FIG. 5 shows a diagram for the illumination of a nightlight comprising the nightlight driving device according to the present invention.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

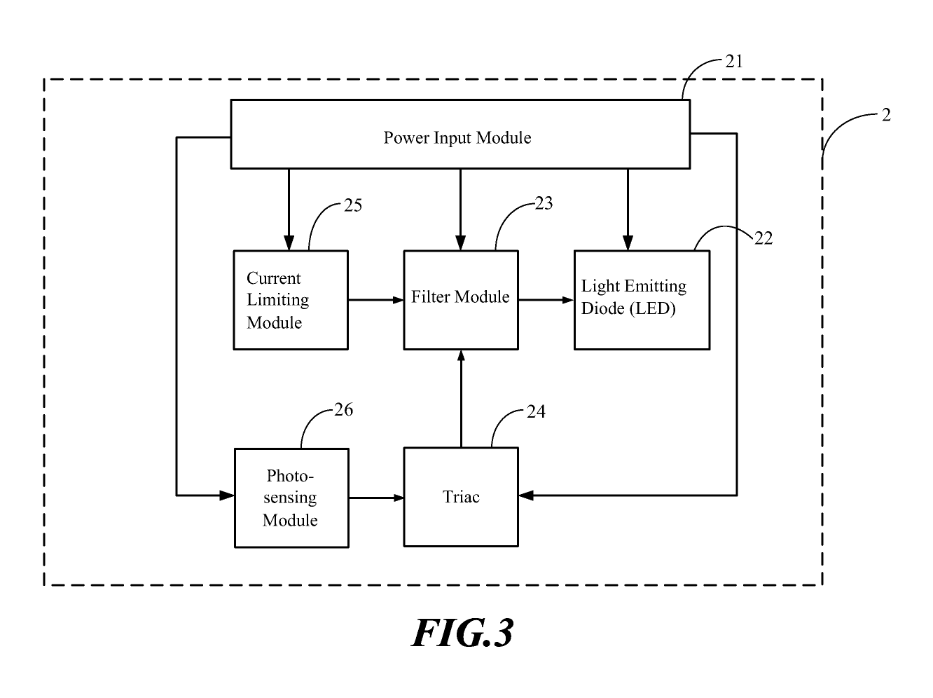

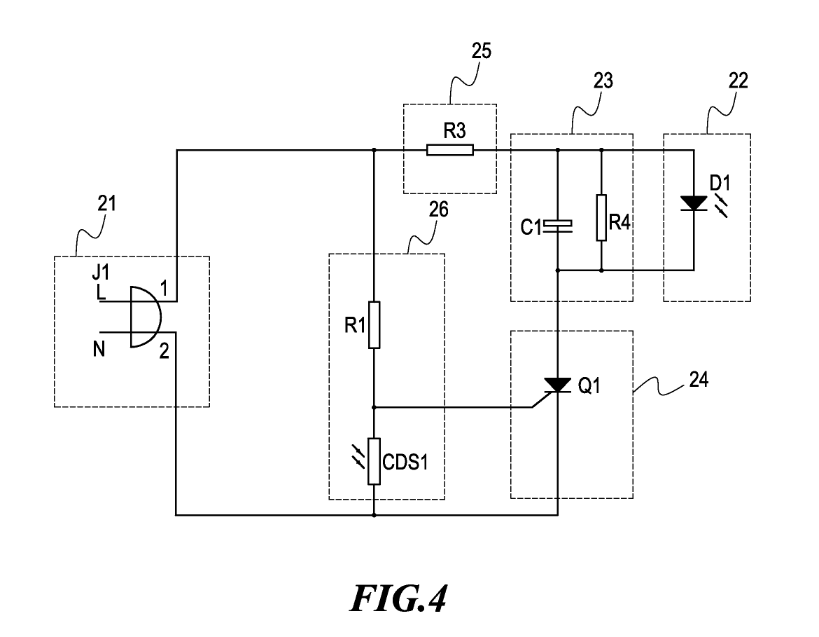

Refer now to FIGS. 3 and 4, wherein a diagram of integral architecture and a diagram of circuit implementation for the nightlight driving device according to the present invention are shown, and it can be seen that the nightlight driving device 2 comprises:

a power input module 21, used to provide the electric power required for entire operations and able to input a current;

a light emitting diode (LED) 22, connected to the power input module 21 in order to illuminate;

a filter module 23, respectively connected to the power input module 21 and the LED 22 and capable of inputting a stable current into the LED 22;

a triac 24, respectively connected to the power input module 21 and the filter module 23 which, in case of conductivity in the triac 24, allows a current to enter into the LED 22 through the filter module 23;

a current limiting module 25, respectively connected to the power input module 21 and the filter module 23, which, in case of conductivity in the triac 24, limits the current flowing into the LED 22;

a photo-sensing module 26, respectively connected to the triac 24 and the power input module 21, which determines the conductivity in the triac 24 based on the intensity of light. Furthermore, the photo-sensing module 26 includes a photosensitive resistor CDS₁ and a resistor R₁, wherein the resistance of the photosensitive resistor CDS₁ varies in accordance with the intensity of light (the stronger the intensity of light becomes, the smaller the resistance of the photosensitive resistor CDS₁ is; contrarily, the lower the intensity of light is, the greater the resistance of the photosensitive resistor CDS₁ demonstrates). Therefore, when the resistance of the photosensitive resistor CDS₁ in the photo-sensing module 26 is excessively small, the triac 24 will be closed; contrarily, in case that the resistance of the photosensitive resistor CDS₁ in the photo-sensing module 26 is sufficiently large, the triac 24 will become conductive.

As a result, when the photo-sensing module 26 is in an environment of daytime providing strong intensity of light, the photo-sensing module 26 makes the triac 24 unable to be driven to conduct and the LED 22 unable to illuminate either. Alternatively, as the photo-sensing module 26 is in an environment of nighttime providing weak intensity of light, the triac 24 can be driven to conduct and the LED 22 can illuminate.

It should be noted that the current limiting module 25 is a current limiting resistor R₃.

It should be noted that the triac 24 is a triac Q₁.

It should be noted that the filter module 23 consists of a capacitor C₁ and a resistor R₄.

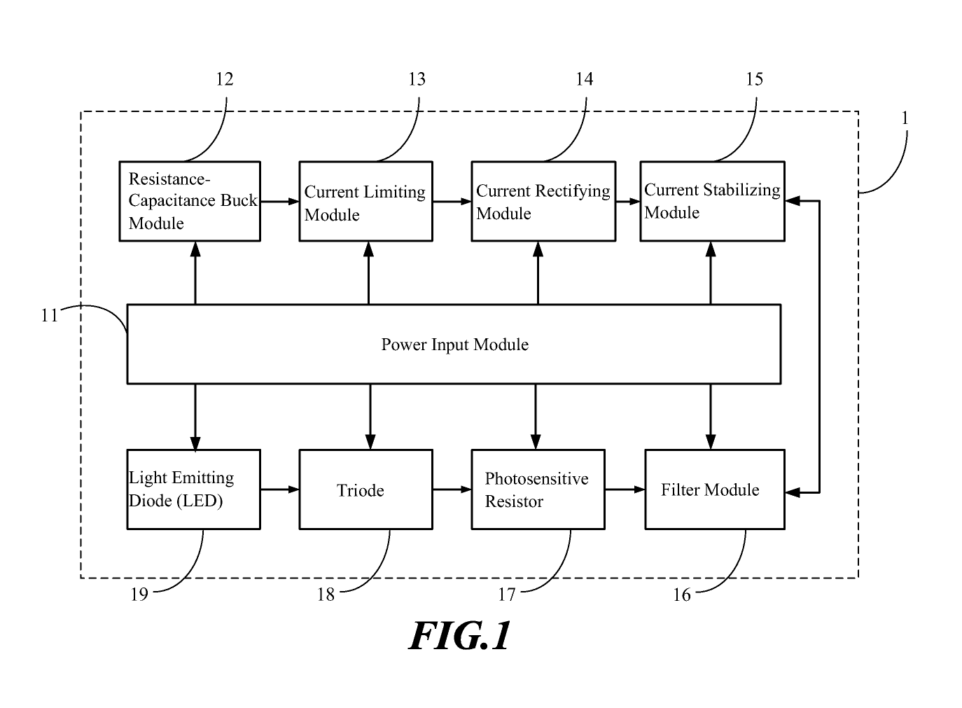

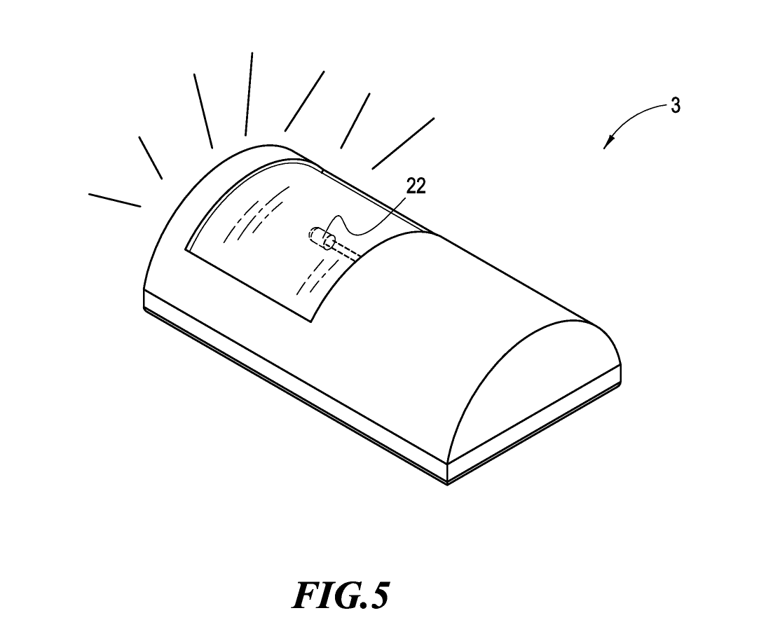

Refer next conjunctively to FIGS. 1 and 5, wherein diagrams for illumination of nightlight comprising the nightlight driving device according to the present invention are shown. It can be observed from the Figures that the nightlight driving device 2 is installed inside the nightlight 3 in which, when the photo-sensing module 26 is in an environment of daytime providing strong intensity of light, the photo-sensing module 26 makes the triac 24 unable to be driven to conduct and the current unable to flow through the current limiting module 25, the triac 24, the filter module 23 and the LED 22, so the LED 22 can not illuminate.

However, suppose the photo-sensing module 26 is in an environment of nighttime providing reduced intensity of light, the triac 24 can be driven to conduct and the current can flow through the current limiting module 25, the triac 24, the filter module 23 and, finally, into the LED 22 thereby causing the LED 22 to illuminate.

Compared with prior art, the nightlight driving device provided by the present invention further offers the following advantages:

1. the present invention can be effectively built with compact and simplified circuitry thereby saving valuable manufacture costs and work times;

2. the present invention uses a triac as the switch to turn on/off the LED, and the triac consumes no electric power when the LED does not emit light during daytime thus achieving the purpose of energy saving.

By way of the aforementioned detailed descriptions for the preferred embodiments according to the present invention, it is intended to better illustrate the characteristics and spirit of the present invention rather than restricting the scope of the present invention to the preferred embodiments disclosed in the previous texts. Contrarily, the objective is to encompass all changes and effectively equivalent arrangements within the scope of the present invention as delineated in the following claims of the present application.

What is claimed is:

1. A nightlight driving device, comprising:
a power input module, used to provide the electric power required for entire operations and able to input a current;
a light emitting diode (LED), connected to the power input module in order to illuminate;
a filter module, respectively connected to the power input module and the LED and capable of inputting a stable current into the LED;
a triac, respectively connected to the power input module and the filter module which, in case of conductivity in the triac, allows a current to enter into the LED through the filter module;
a current limiting module, respectively connected to the power input module and the filter module, which, in case of conductivity in the triac, limits the current flowing into the LED; and
a photo-sensing module, respectively connected to the triac and the power input module, which determines the conductivity in the triac based on the intensity of light.

2. The nightlight driving device according to claim 1, wherein the photo-sensing module includes a photosensitive resistor CDS and a resistor R, and the resistance of the photosensitive resistor CDS varies based on the intensity of light.

3. The nightlight driving device according to claim 1, wherein the current limiting module is a current limiting resistor R.

4. The nightlight driving device according to claim 1, wherein the filter module includes a capacitor and a resistor thereby forming an RC filter circuit.
